(19) United States
(12) Patent Application Publication
(10) Pub. No.: US 2025/0224014 A1
(43) Pub. Date: Jul. 10, 2025

(54) DAMPER DEVICE

(71) Applicants: ATSUMITEC CO., LTD., Hamamatsu-shi, Shizuoka (JP); National University Corporation Shizuoka University, Shizuoka-shi, Shizuoka (JP)

(72) Inventors: Masaki KANATORI, Hamamatsu-shi (JP); Junichi ISHIMOTO, Hamamatsu-shi (JP); Tomotaka ITO, Hamamatsu-shi (JP); Hiromi SHIMIZU, Hamamatsu-shi (JP)

(21) Appl. No.: 18/850,700

(22) PCT Filed: Feb. 9, 2023
(86) PCT No.: PCT/JP2023/004348

§ 371 Date: Sep. 25, 2024

(30) Foreign Application Priority Data
Mar. 30, 2022 (JP) 2022-056146

(51) Int. Cl. F16F 9/53

(52) U.S. Cl. CPC F16F 9/535

(57) ABSTRACT

A magneto-rheological damper includes a cylinder including a magneto-rheological fluid with a viscosity that is changeable in accordance with magnetic field application, a piston movable in the cylinder and partitioning the cylinder into first and second compartments, a fluid passage enabling the first compartment and the second compartment to communicate with each other, and an electromagnet including an electromagnetic coil and an iron core pipe. A magnetic field is applicable to the fluid passage by energizing the electromagnetic coil to increase a flow resistance of the magneto-rheological fluid in the fluid passage so that movement resistance is applied to an object connected to the piston. The fluid passage includes: a first fluid passage facing one end portion of the iron core pipe and to which the magnetic field is applied by the electromagnetic coil, and a second fluid passage extending through the iron core pipe.

### BACKGROUND OF THE INVENTION

### 1. Field of the Invention

The present invention relates to damper devices using a magneto-rheological fluid.

### 2. Description of the Related Art

In recent years, a damper device using a magneto-rheological fluid (hereinafter, referred to as an MR damper) has been developed. The magneto-rheological fluid is a fluid whose viscosity increases when a magnetic field is applied.

JP 2002-168283 A discloses a piston cylinder type MR damper. The MR damper of JP 2002-168283 A has a configuration in which compartments are provided on both sides of a piston that moves in a cylinder, the compartments on both sides are made to communicate with each other and sealed by a communication path having a small diameter, and electromagnets are arranged around the communication path. By applying a magnetic field by the electromagnets to increase the viscosity of a magneto-rheological fluid, the flow resistance of the magneto-rheological fluid moving through the communication path is increased. Accordingly, the movement of the piston is reduced or prevented, and an object connected to the piston can be damped. Furthermore, by changing a current to be supplied to the electromagnets to change the flow resistance of the magneto-rheological fluid, the damping force can be easily changed.

### SUMMARY OF THE INVENTION

The cylinder type damper device using a magneto-rheological fluid as in JP 2002-168283 A is used, for example, for a suspension device of a vehicle or damping of a building, and is often used for purposes with a large load. However, in order to handle a large load, it is necessary to arrange a large number of electromagnets or to increase the size of the electromagnets, and there is a problem in that the size of the damper device increases.

In addition, although the size of the damper device can be reduced by reducing the size of the electromagnets, there is a problem in that a control range of the flow resistance is reduced, and a range in which the damping force can be changed, that is, a range in which the applied load can be handled is narrowed.

Example embodiments of the present invention provide damper devices using a magneto-rheological fluid, which are small in size and can handle a wide range of applied loads.

A damper device according to an example embodiment of the present invention includes a cylinder including a magneto-rheological fluid with a viscosity that is changeable in accordance with magnetic field application, a movable body moveable in the cylinder and partitioning the cylinder into a first compartment and a second compartment, a fluid passage to enable the first compartment and the second compartment to communicate with each other, and an electromagnet including an electromagnetic coil and an iron core inserted into the electromagnetic coil, wherein a magnetic field is applicable to the fluid passage by energizing the electromagnetic coil to increase a flow resistance of the magneto-rheological fluid in the fluid passage so that resistance is applied to movement of the movable body; and the fluid passage includes a first fluid passage facing one end portion of the iron core, and a second fluid passage extending through the iron core, wherein the first fluid passage and the second fluid passage are positioned such that the magnetic field is applicable by the electromagnetic coil to the magneto-rheological fluid in each of the first fluid passage and the second fluid passage.

Preferably, the second fluid passage may include a flow passage that connects one end of the first fluid passage and the first compartment, and a flow passage that connects the other end of the first fluid passage and the second compartment.

Preferably, three or more of the electromagnets may be positioned in parallel or substantially in parallel, the first fluid passage may be positioned along first end portions of the iron cores of the three or more of the electromagnets, and the second fluid passage may extend through insides of the iron cores of the three or more of the electromagnets positioned at both ends of the three or more of the electromagnets.

Preferably, a metal plate defining a yoke of the electromagnet may be provided so as to face the first fluid passage.

Preferably, the first fluid passage may be between a plurality of laminated plates.

Preferably, the first fluid passage and the second fluid passage may be connected at an angle.

Preferably, a flow passage cross-sectional area changer to change a flow passage cross-sectional area of the first fluid passage may be provided at a position at or adjacent to a connecting portion between the first fluid passage and the second fluid passage.

Preferably, the first fluid passage may be provided inside the yoke, the second fluid passage may be provided inside the iron core, the iron core may be inserted into and connected to the yoke, and the flow passage cross-sectional area changer may change the flow passage cross-sectional area of the first fluid passage by connecting the iron core to the yoke while changing the amount of insertion of the iron core into the yoke.

According to example embodiments of the present invention, the movement of the movable body is reduced or prevented by the flow resistance of the magneto-rheological fluid passing through the fluid passage. Accordingly, for example, the vibration of a body to be damped, which is connected to the movable body, can be reduced or prevented. Moreover, the magnetic field is applied to the first fluid passage by the electromagnet, so that the viscosity of the magneto-rheological fluid passing through the fluid passage can be increased, and the flow resistance can be increased. Therefore, the movement of the movable body can be easily strongly reduced or prevented by energizing the electromagnetic coil of the electromagnet.

Furthermore, since the fluid passage includes the first fluid passage facing the one end portion of the iron core of the electromagnet and to which the magnetic field is applied by the electromagnetic coil, and the second fluid passage that extends through the inside of the iron core, not only the flow resistance of the magneto-rheological fluid passing through the first fluid passage is increased by energizing the electromagnetic coil, but also the flow resistance of the connecting portion with the first fluid passage is intensively increased by applying the magnetic field even when the magneto-rheological fluid passes through the second fluid passage in the iron core.

Accordingly, the viscosity of the magneto-rheological fluid passing through the fluid passage is largely increased to greatly increase the flow resistance by the small electromagnet. Thus, damper devices capable of handling a wide range of applied loads can be provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a shape of an MR damper of an example embodiment of the present invention.

FIG. 2 is a vertical cross-sectional view illustrating an internal structure of the MR damper of the present example embodiment of the present invention.

FIG. 3 is an explanatory view illustrating a shape of a first fluid passage in the MR damper of the present example embodiment of the present invention.

FIG. 4 is a vertical cross-sectional view illustrating a structure of a connecting portion between iron core pipes and a yoke in the MR damper of the present example embodiment of the present invention.

FIG. 5 is an explanatory view of a fluid route and a magnetic field to be generated in the MR damper of the present example embodiment of the present invention.

FIG. 6 is a schematic structural view of an MR damper of another example embodiment of the present invention.

### DETAILED DESCRIPTION OF THE EXAMPLE EMBODIMENTS

Hereinafter, example embodiments of the present invention will be described in detail with reference to the drawings.

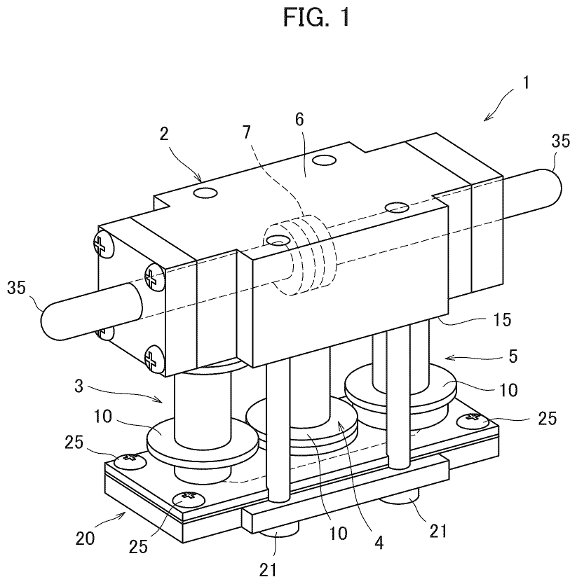

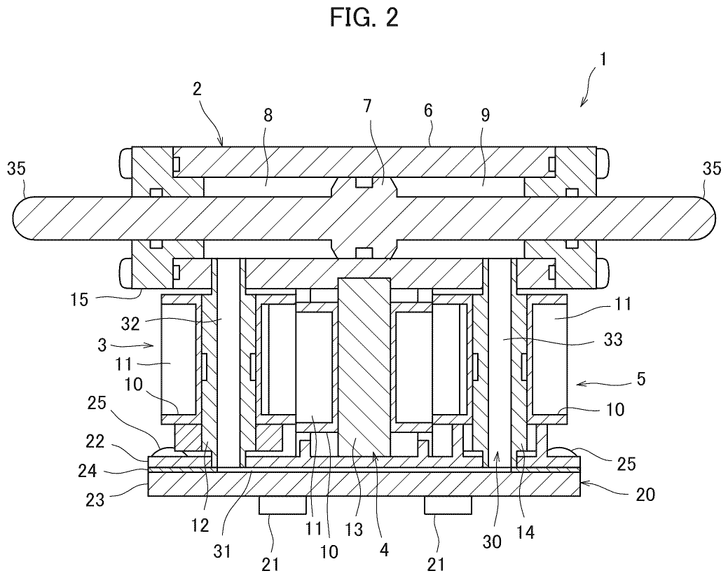

FIG. 1 is a perspective view illustrating a shape of an MR damper 1 (damper device) of an example embodiment of the present invention. FIG. 2 is a vertical cross-sectional view illustrating an internal structure of the MR damper 1 of the present example embodiment. In FIG. 1, a winding portion of an electromagnetic coil which will be described below is omitted.

The MR damper is a damper using a magneto-rheological fluid. The magneto-rheological fluid is, for example, a fluid including iron powder, and the viscosity thereof increases when a magnetic field is applied.

The MR damper can easily change the damping performance by applying a magnetic field by an electromagnet to increase the viscosity of the magneto-rheological fluid. The MR damper is used in, for example, a suspension device of a vehicle or a vibration isolation device of a building.

The MR damper 1 of the present example embodiment is a relatively small MR damper used in, for example, a shift device of a vehicle.

As illustrated in FIGS. 1 and 2, the MR damper 1 of the present example embodiment is a piston cylinder type MR damper. The MR damper 1 includes a piston cylinder 2 and three electromagnets 3, 4, and 5, for example.

The piston cylinder 2 is partitioned into a first compartment 8 and a second compartment 9 by a piston 7 (movable body) movable in a cylindrical cylinder 6 having a rectangular parallelepiped outer shape.

The electromagnets 3, 4, and 5 include electromagnetic coils 11 each of which has a substantially cylindrical shape by winding an electric wire around a bobbin 10, and iron cores 12, 13, and 14 each of which is inserted into the bobbin 10. The electromagnets 3, 4, and 5 are adjacent to the cylinder 6 and arranged side by side in an axial direction of the cylinder 6.

The iron cores 12, 13, and 14 are supported by one sidewall 15 of the cylinder 6 at one end portions thereof, extend in a direction perpendicular to and separated from the axial direction of the cylinder 6, and are supported by a rectangular plate-shaped yoke 20 at the other end portions thereof.

The yoke 20 is arranged to be separated from and parallel or substantially parallel to the one sidewall 15 of the cylinder 6, and is fixed to the cylinder 6 by, for example, four bolts 21. That is, the three electromagnets 3, 4, and 5 are arranged side by side in the axial direction of the cylinder 6 between the one sidewall 15 of the cylinder 6 and the yoke 20.

In addition, the iron core 13 of the central electromagnet 4 among the three electromagnets 3, 4, and 5 arranged side by side has a columnar shape, and the iron cores 12 and 14 of the electromagnets 3 and 5 on both outer sides have a cylindrical shape. Hereinafter, the iron cores 12 and 14 of the electromagnets 3 and 5 on both outer sides will be referred to as iron core pipes 12 and 14.

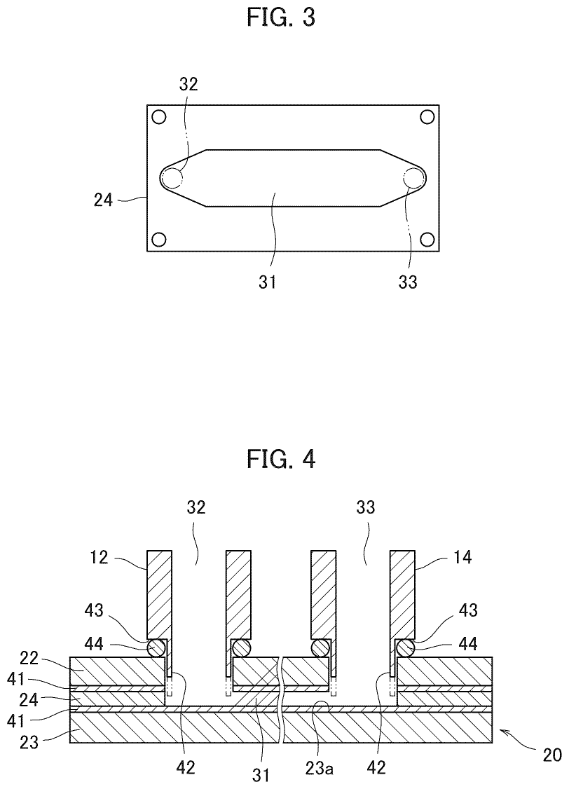

The yoke 20 is provided by sandwiching one spacer 24 between two rectangular flat plates 22 and 23 and fixing the spacer 24 to the plates 22 and 23, for example, at four corners thereof with screws 25. The two plates 22 and 23 and the spacer 24 have the same or substantially the same outer shape. The spacer 24 is, for example, a non-magnetic material, such as aluminum, having a thickness of about a little less than about 1 mm, and as illustrated in FIG. 3, the inside thereof is hollowed out so as to extend in the longitudinal direction. The two plates 22 and 23 sandwich the one spacer 24, so that the hollowed-out portion of the spacer 24 defines and functions as a first fluid passage 31 that is an internal space having a thickness of about a little less than about 1 mm, for example.

The cover plate 22, on the side of the cylinder 6, of the two plates 22 and 23 is formed of a non-magnetic material, such as aluminum, having a thickness of about several millimeters, for example. The yoke plate 23 on the side opposite to the cylinder 6 is a yoke main body, and is a magnetic material such as a relatively thick iron plate (metal plate). The cover plate 22 is in contact with the other end portion of the iron core 13 of the electromagnet 4 located at the center, and is provided with holes into which the other end portions of the iron core pipes 12 and 14 are respectively inserted. The two holes of the cover plate 22 communicate with each other near both end portions of the first fluid passage 31 of the yoke 20. That is, holes in the iron core pipes 12 and 14 communicate with each other through the first fluid passage 31 in the yoke 20.

In the MR damper 1, a fluid passage 30 that makes the first compartment 8 and the second compartment 9 communicate with each other is provided.

The fluid passage 30 includes the first fluid passage 31 that is the internal space located in the yoke 20, and second fluid passages 32 and 33 that are the holes in the iron core pipes 12 and 14.

The second fluid passage 32 provided in the iron core pipe 12 is configured to connect one end of the first fluid passage 31 and the first compartment 8. The second fluid passage 33 provided in the iron core pipe 14 is configured to connect the other end of the first fluid passage 31 and the second compartment 9.

The first compartment 8 and the second compartment 9 of the cylinder 6 and the fluid passage 30 are sealed from the outside, and are tightly filled with the above-described magneto-rheological fluid.

A piston rod 35 is connected to the piston 7 in the cylinder 6. The piston rod 35 protrudes outward from both end portions of the cylinder 6. The cylinder 6 is fixed to, for example, a base, and an end portion of the piston rod 35 is connected to an object to which the movement resistance is applied.

FIG. 4 is a vertical cross-sectional view illustrating a shape of a connecting portion between the iron core pipes 12 and 14 and the yoke 20.

Thin plate-shaped seal structures 41 are provided between the cover plate 22 and the spacer 24 and between the yoke plate 23 and the spacer 24, respectively. The seal structure 41 has substantially the same outer shape as the spacer 24, and is hollowed out in the same shape as the first fluid passage 31.

An end portion of each of the iron core pipes 12 and 14 on the side of the yoke 20 preferably has a small thickness by cutting the outer peripheral wall surface side thereof. As a result, at the end portion of each of the iron core pipes 12 and 14, a protruding portion 42 obtained by making the inner wall surface side thereof protrude is formed, and a step 43 is provided on the outer peripheral side of the protruding portion 42.

In addition, in order to prevent leakage of the fluid to the outside at the connecting portion between each of the iron core pipes 12 and 14 and the yoke 20, a ring-shaped seal structure 44 which has elasticity like rubber and is relatively thick is sandwiched between the cover plate 22 and the step 43 of each of the iron core pipes 12 and 14.

The amount of insertion of the iron core pipes 12 and 14 into the yoke 20 can be changed by changing the amount of tightening of the bolts 21. For example, by increasing the amount of tightening of the bolts 21, as indicated by the dash-double-dot line in FIG. 4, a gap between distal ends of the protruding portions 42 of the iron core pipes 12 and 14 and a surface 23a of the yoke plate 23 on the side of the first fluid passage 31 is reduced, and a flow passage cross-sectional area of the first fluid passage 31 in the vicinity of the connecting portion between the iron core pipes 12 and 14 and the yoke 20 is reduced.

In addition, several types of spacers 24 having different thicknesses may be prepared in advance, and the flow passage cross-sectional area of the first fluid passage 31 may be changed by replacing the spacer 24 to change the thickness thereof.

A structure for changing the flow passage cross-sectional area of the first fluid passage 31 by the protruding portions 42 or the like in the vicinity of the connecting portion between the iron core pipes 12 and 14 and the yoke 20 corresponds to a flow passage cross-sectional area changer of an example embodiment of the present invention.

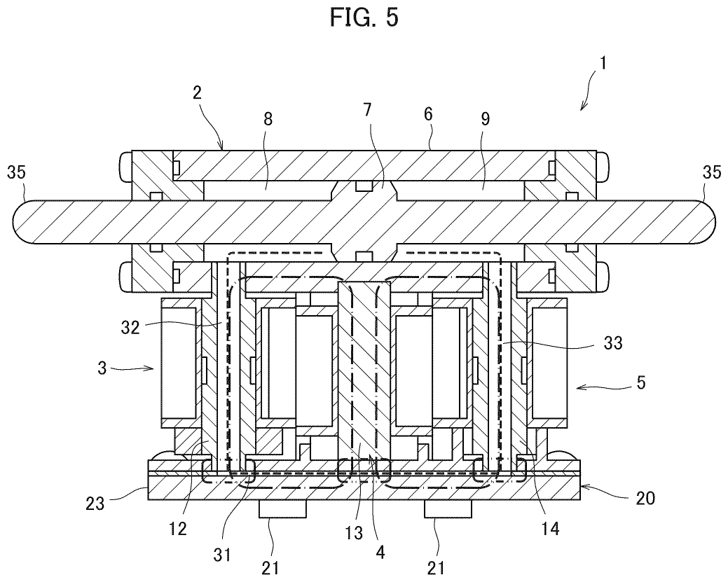

According to the above-described configuration, in the MR damper 1, when the piston 7 moves to either the left or the right, as indicated by the broken line in FIG. 5, the magneto-rheological fluid moves from one to the other of the first compartment 8 and the second compartment 9 through the fluid passage 30 (the first fluid passage 31 and the second fluid passages 32 and 33). At this time, since the magneto-rheological fluid passes through the first fluid passage 31 that is a space having a thickness of about a little less than about 1 mm, for example, the movement of the magneto-rheological fluid is reduced or prevented by the flow resistance in the first fluid passage 31. The thickness of about a little less than about 1 mm of the space serving as the first fluid passage 31 is merely an example, and a range of thickness to be set may be widened. For example, the range of thickness may be from about 0.2 mm to about 2 mm, and more preferably from about 0.3 mm to about 1 mm.

Accordingly, the movement of the piston 7 is reduced or prevented, and the movement resistance can be applied to the object connected to the piston rod 35 with respect to the base connected to the cylinder 6.

In addition, by supplying, for example, a direct current to electromagnetic coils 11 of the electromagnets 3, 4, and 5, a magnetic field is generated in the iron cores 12, 13, and 14 and around the iron cores 12, 13, and 14 as indicated by the dash-dot line in FIG. 5. The electromagnets 3, 4, and 5 are energized such that the electromagnets 3 and 5 and the electromagnet 4 generate a magnetic field in directions opposite to each other, and the magnetic field is applied to the iron cores 12, 13, and 14 and around the iron cores 12, 13, and 14, so that the viscosity of the magneto-rheological fluid passing through the first fluid passage 31 arranged to face the end portions of the iron cores 12, 13, and 14 of the electromagnets 3, 4, and 5 can be increased, and the flow resistance can be increased. Therefore, the movement resistance of the piston 7 can be increased by energizing the electromagnets 3, 4, and 5.

Furthermore, since the fluid passage 30 for the magneto-rheological fluid, which connects the first compartment 8 and the second compartment 9, includes not only the first fluid passage 31 but also the second fluid passages 32 and 33 passing through the iron core pipes 12 and 14 of the electromagnets 3 and 5, the magnetic field is applied even when the magneto-rheological fluid passes through the second fluid passages 32 and 33 by the energization to the electromagnetic coils 11 of the electromagnets 3 and 5, and the flow resistance is further increased in the vicinity of a connecting portion between the second fluid passages 32 and 33 and the first fluid passage 31. In addition, by providing the second fluid passages 32 and 33 in the iron core pipes 12 and 14, a more perpendicular magnetic field can be effectively applied.

A portion where the viscosity of the magneto-rheological fluid is increased by the energization to the electromagnets 3, 4, and 5 is indicated by the dash-double-dot line in FIG. 5.

Accordingly, the flow resistance of the magneto-rheological fluid passing through the fluid passage 30 is largely increased by the small electromagnets 3, 4, and 5, and the movement resistance of the piston 7 can be further increased.

In addition, in the present example embodiment, the yoke plate 23 including a metal plate is provided on an outer side (the side opposite to the cylinder 6) so as to face the first fluid passage 31, and the yoke plate 23 defines and functions as yokes of the electromagnets 3, 4, and 5. Therefore, the magnetic field generated by the electromagnets 3, 4, and 5 can be further concentrated on the first fluid passage 31, in particular, the vicinity of the connecting portion between the first fluid passage 31 and the second fluid passage 32, and the flow resistance of the magneto-rheological fluid can be further largely increased.

In addition, the yoke 20 preferably is formed by laminating the plate 22, the spacer 24, and the plate 23, and the first fluid passage 31 preferably is formed between the plate 22 and the plate 23, for example. Therefore, the flow passage cross-sectional area of the first fluid passage 31 can be easily changed by replacing the spacer 24 sandwiched between the plates 22 and 23 with a spacer having a different thickness. Accordingly, a settable range of the movement resistance of the piston 6 and thus a settable range of the damping force of the MR damper 1 can be easily changed to different specifications.

In the present example embodiment, the three electromagnets 3, 4, and 5 are arranged side by side on the one sidewall of the cylinder 6, the first fluid passage 31 is arranged along one end portions of the electromagnetic coils 11 of the electromagnets 3, 4, and 5 arranged in parallel or substantially in parallel, and the second fluid passages 32 and 33 are arranged to pass through the inside of the iron core pipes 12 and 14 of the electromagnets 3 and 5 positioned at both ends of the electromagnets 3, 4, and 5 arranged in parallel or substantially in parallel.

Therefore, the three electromagnets 3, 4, and 5 and the fluid passage 30 for the magneto-rheological fluid, which connects the first compartment 8 and the second compartment 9, can be formed compactly together with the cylinder 6.

In addition, the first fluid passage 31 and the second fluid passages 32 and 33 are connected at an angle of about 90 degrees, for example. Therefore, the flow resistance increases when the magneto-rheological fluid passes through the connecting portion. In particular, since the first fluid passage 31 has a relatively small flow passage cross-sectional area, the flow resistance of the magneto-rheological fluid largely increases when the magneto-rheological fluid flows into the first fluid passage 31 from the second fluid passages 32 and 33.

Furthermore, since the magnetic field is applied in the second fluid passages 32 and 33, the viscosity of the magneto-rheological fluid can be increased before the magneto-rheological fluid flows into the first fluid passage 31 from the second fluid passages 32 and 33, and the flow resistance when the magneto-rheological fluid flows into the first fluid passage 31 from the second fluid passages 32 and 33 can be more largely increased.

In addition, in the present example embodiment, the amount of insertion of the iron core pipes 12 and 14 into the yoke 20 can be easily changed by changing the amount of tightening of the bolts 21. By changing the amount of insertion of the iron core pipes 12 and 14 into the yoke 20, the flow passage cross-sectional area of the first fluid passage 31 can be easily changed in the vicinity of the connecting portion between the yoke 20 and the iron core pipes 12 and 14, that is, in the vicinity of the connecting portion between the first fluid passage 31 and the second fluid passages 32 and 33. Therefore, the flow resistance of the magneto-rheological fluid when the magneto-rheological fluid passes through the vicinity of the connecting portion between the first fluid passage 31 and the second fluid passages 32 and 33 can be easily changed by a compact and simple configuration.

In addition, by changing the amount of insertion of the iron core pipes 12 and 14 into the yoke 20 to narrow a flow passage width of the first fluid passage 31 in the vicinity of the connecting portion between the first fluid passage 31 and the second fluid passages 32 and 33, the magnetic flux density by the electromagnets 3, 4, and 5 in the narrowed flow passage portion for the magneto-rheological fluid is increased, and the flow resistance of the magneto-rheological fluid can be further increased due to the further increase in the viscosity of the magneto-rheological fluid and the increase in shear resistance.

As described above, by changing the amount of insertion of the iron core pipes 12 and 14 into the yoke 20, the flow resistance of the magneto-rheological fluid can be greatly increased in combination with the increase in the flow resistance of the magneto-rheological fluid and the increase in the magnetic flux density of the magnetic field applied to the magneto-rheological fluid, and the movement resistance of the piston 7 in the MR damper 1 can be easily and largely changed.

In addition, since the flow passage cross-sectional area of the first fluid passage 31 which has a small flow passage cross-sectional area and is located just behind a bend of the fluid passage 30 from the second fluid passages 32 and 33 toward the first fluid passage 31 is changed, the flow resistance can be largely changed even when the flow passage cross-sectional area is slightly changed.

For example, when the present example embodiment is compared with a comparative example in which the second fluid passages 32 and 33 are not provided in the electromagnets 3 and 5 as in the case where electromagnets are provided not around but outside the second fluid passages 32 and 33 to apply a magnetic field, for more information, a comparative example in which a magnetic field is applied only to the first fluid passage 31, and other conditions such as the flow passage cross-sectional area, length, and connection angle of the first fluid passage 31 and the second fluid passages 32 and 33, the number of turns in the electromagnetic coils 11 of the electromagnets 3, 4, and 5, and a flowing electric current are the same as those in the present example embodiment, in the case where the flow passages (the second fluid passages 32 and 33) are provided in the iron cores of the electromagnets 3 and 5 as in the present example embodiment, the flowing electric current of the electromagnetic coils 11 is increased, and the movement resistance of the piston 7 can be largely increased.

As described above, by providing the second fluid passages 32 and 33 in the iron core pipes 12 and 14 of the electromagnets 3 and 5, the movement resistance of the piston 7 can be largely changed with respect to the current change of the electromagnets 3, 4, and 5. In particular, by combining the configuration in which the second fluid passages 32 and 33 and the first fluid passage 31 having a small flow passage cross-sectional area are connected at an angle of about 90 degrees, for example, the movement resistance of the piston 7 can be more considerably changed with respect to the current change of the electromagnets 3, 4, and 5. Therefore, the MR damper 1 capable of handling a wide range of applied load and largely changing the movement resistance (damping force) while being compact can be provided.

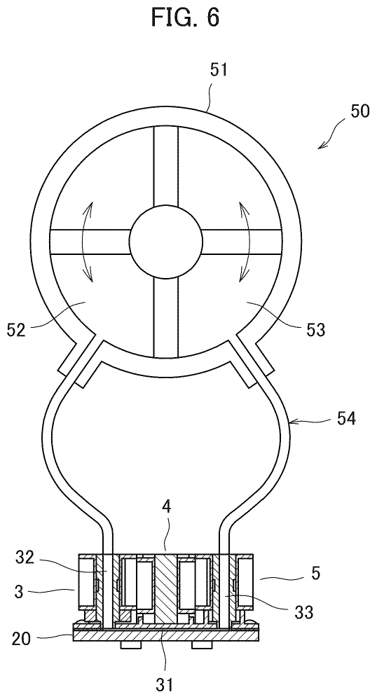

Example embodiments have been described above, but the present invention is not limited to the above-described example embodiments. For example, the above-described example embodiments are applicable to the piston cylinder type MR damper 1, but the example embodiments of the present invention can also be applied to a rotary cylinder type MR damper. For example, as illustrated in FIG. 6, an MR damper 50 (damper device) may be configured to include a unit in which the electromagnets 3, 4, and 5, the first fluid passage 31, and the second fluid passages 32 and 33 as in the present example embodiment are arranged in a fluid passage 54 that connects two compartments 52 and 53 of a rotary cylinder 51.

Moreover, although the three electromagnets 3, 4, and 5 are provided in the present example embodiment, three or more electromagnets may be provided, or only the electromagnets 3 and 5 at both ends may be provided. When only the electromagnets 3 and 5 at both ends are provided, since lines of magnetic force of the electromagnets 3 and 5 pass through the same iron core pipes 12 and 14, the direction of the direct current to be supplied to the electromagnetic coils 11 of the electromagnets 3 and 5 may be set so as not to cancel the magnetic field.

Moreover, in each of the above-described example embodiments, the detailed structures of various components can be appropriately changed. For example, the shape of the first fluid passage 31 may be appropriately changed according to the required specification of the MR damper, such as the movement resistance (damping force) at the time of non-energization or at the time of energization.

Moreover, the above-described MR damper 1 is used as an actuator to provide a click feeling when, for example, a shift lever is moved to each position in a shift device of a transmission. Accordingly, an operation feeling of the shift lever can be appropriately and easily changed. However, the MR dampers 1 and 50 of the present example embodiments may be used for damping. Example embodiments of the present invention can be widely applied to an MR damper used for various purposes other than the shift device of the transmission.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-8. (canceled)

9. A damper device comprising:
a cylinder including a magneto-rheological fluid with a viscosity that is changeable in accordance with magnetic field application;
a movable body moveable in the cylinder and partitioning the cylinder into a first compartment and a second compartment;
a fluid passage to enable the first compartment and the second compartment to communicate with each other; and
an electromagnet including an electromagnetic coil and an iron core inserted into the electromagnetic coil; wherein
a magnetic field is applicable to the fluid passage by energizing the electromagnetic coil to increase a flow resistance of the magneto-rheological fluid in the fluid passage so that resistance is applied to movement of the movable body; and
the fluid passage includes:
a first fluid passage facing one end portion of the iron core; and
a second fluid passage extending through the iron core; wherein
the first fluid passage and the second fluid passage are positioned such that the magnetic field is applicable by the electromagnetic coil to the magneto-rheological fluid in each of the first fluid passage and the second fluid passage.

10. The damper device according to claim 9, wherein the second fluid passage includes a flow passage that connects one end of the first fluid passage and the first compartment, and a flow passage that connects the other end of the first fluid passage and the second compartment.

11. The damper device according to claim 10, wherein
three or more of the electromagnets are positioned in parallel or substantially in parallel;
the first fluid passage is positioned along first end portions of the iron cores of the three or more of the electromagnets; and
the second fluid passage extends through insides of the iron cores of the three or more of the electromagnets positioned at both ends of the three or more of the electromagnets.

12. The damper device according to claim 9, further comprising a metal plate defining a yoke of the electromagnet and facing the first fluid passage.

13. The damper device according to claim 9, wherein the first fluid passage is between a plurality of laminated plates.

14. The damper device according to claim 9, wherein the first fluid passage and the second fluid passage are connected at an angle.

15. The damper device according to claim 14, wherein a flow passage cross-sectional area changer to change a flow passage cross-sectional area of the first fluid passage is provided at a position at or adjacent to a connecting portion between the first fluid passage and the second fluid passage.

16. The damper device according to claim 15, further comprising a metal plate defining a yoke of the electromagnet and facing the first fluid passage; wherein
the first fluid passage is provided inside the yoke, the second fluid passage is provided inside the iron core, the iron core is inserted into and connected to the yoke; and
the flow passage cross-sectional area changer is operable to change the flow passage cross-sectional area of the first fluid passage by connecting the iron core to the yoke while changing an amount of insertion of the iron core into the yoke.
